(19) United States
(12) Patent Application Publication
(10) Pub. No.: US 2015/0241240 A1
(43) Pub. Date: Aug. 27, 2015

(54) NAVIGATION DEVICE HAVING A ZOOM IN AND ZOOM OUT FEATURE BASED ON A NUMBER OF WAYPOINTS TO BE VIEWED

(71) Applicant: HONDA MOTOR CO., LTD., Tokyo (JP)

(72) Inventor: HAJIME YAMADA, TOKYO (JP)

(73) Assignee: HONDA MOTOR CO., LTD., Tokyo (JP)

(21) Appl. No.: 14/191,151

(22) Filed: Feb. 26, 2014

(51) Int. Cl. G01C 21/36

(52) U.S. Cl. CPC G01C 21/3667; G01C 21/3673

(57) ABSTRACT

A navigation system has a display. A processor is coupled to the display. A memory coupled to the processor. The memory stores program instructions that when executed by the processor, causes the processor to: calculate a route from a present location to a desired destination; display on the display a graphical representation of a map showing the present location and a desired number of waypoints along the route calculated, wherein the desired number of waypoints is entered by a user through a user interface of the navigation system.

### TECHNICAL FIELD

The present application generally relates to a vehicle navigational system, and, more particularly, to a vehicle navigation system having a zoom in and zoom out feature which allows one to view a desired number of waypoints ahead of a current location.

### BACKGROUND

Many vehicles may now be equipped with navigations systems. Vehicle navigation systems may be used to search for and calculate a route from a current location of the vehicle to a desired destination. To accomplish this, typical vehicle navigation systems may be configured to allow a user to enter a name or address of the desired destination. The user may also perform a search for different types of “points of interest” such as nearest gas station, restaurants or the like and then select one of the “points of interest” selected. The vehicle navigation system may then calculate a preferred route to the desired destination.

The vehicle navigation system may show the preferred route calculated on a display unit. The display unit may show a graphical representation of a map showing the present location of the vehicle as the vehicle moves along a highlighted path to the desired destination. The display may also show textual directions along with the graphical representation of a map showing the present location of the vehicle. The vehicle navigation system may further provide audible directions to the driver.

Present vehicle navigation systems are beneficial in helping drivers navigate the vehicle to the desired destination. However, the displays of the vehicle navigation systems generally only provide a limited view of the graphical representation of the map. As stated above, the displays generally only show the graphical representation of the map of the present location of the vehicle along with a highlighted pathway of the road. Present vehicle navigation systems have limited functionality and generally do not allow the driver to zoom in or zoom out to see upcoming and or future waypoints on the calculated route.

Therefore, it would be desirable to provide a vehicle navigation system and method that overcome the above problems.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

A navigation system has a display. A processor is coupled to the display. A memory coupled to the processor. The memory stores program instructions that when executed by the processor, causes the processor to: calculate a route from a present location to a desired destination; and display on the display a graphical representation of a map showing the present location and a desired number of waypoints along the route, wherein the desired number of waypoints is entered by a user through a user interface of the navigation system.

A navigation system has a processor. A location determining unit is coupled to the processor. A display is coupled to the processor. A user interface is coupled to the processor for entering data into the navigation system, wherein the user interface is configured to enter a desired number of waypoints to be viewed. A memory is coupled to the processor. The memory stores program instructions that when executed by the processor, causes the processor to: determine a present location of the navigation system by receiving data from the location determining unit; calculate a route from the present location to a desired destination; and display on the display a graphical representation of a map showing the present location and the desired number of waypoints along the route calculated.

A method of displaying a map on a display of a navigation system comprising: determining a current location of the navigation system; calculating a route from the current location to a desired destination; displaying a map showing the present location; entering a desired number of waypoints ahead of the current location to be viewed; and displaying on the display the map showing the desired number of waypoints along the route calculated.

### BRIEF DESCRIPTION OF DRAWINGS

Embodiments of the disclosure will become more fully understood from the detailed description and the accompanying drawings, wherein:

FIG. 1 is a side view of a vehicle implementing an exemplary navigation system having zoom in and zoom out features based on the number of waypoints desired to be viewed in accordance with one aspect of the present application;

FIG. 2 is a simplified functional block diagram of the exemplary navigation system depicted in FIG. 1;

FIG. 3 shows one embodiment of an initial screen view generated by the exemplary navigation system depicted in FIG. 1;

FIG. 4 shows one embodiment of another screen view generated by the exemplary navigation system depicted in FIG. 1;

FIG. 5 is another embodiment of an additional screen view generated by the exemplary navigation system depicted in FIG. 1; and

FIG. 6 is another embodiment of an additional screen view generated by the exemplary navigation system depicted in FIG. 1.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

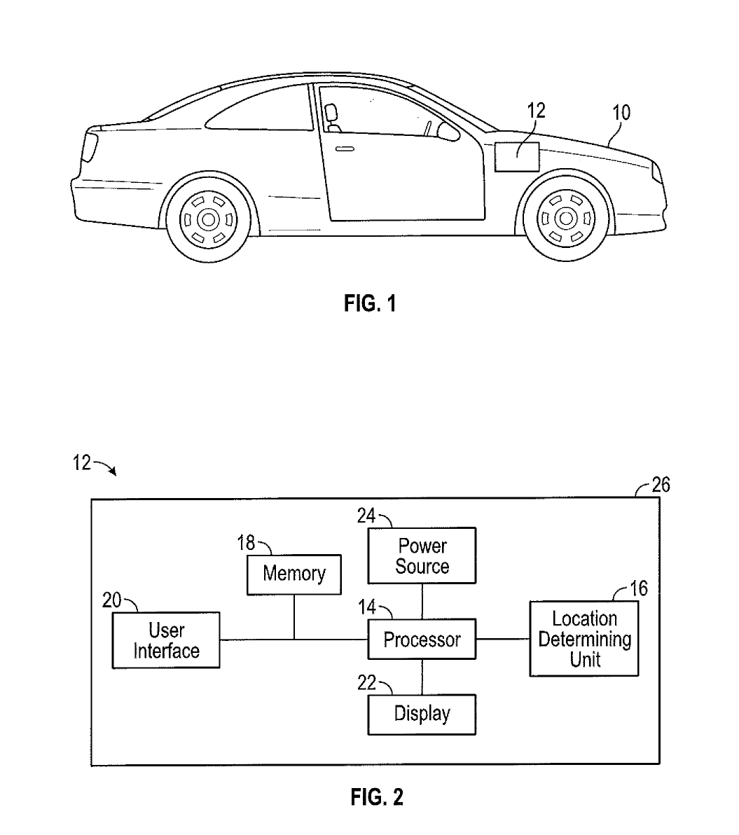

Referring to FIG. 1, an exemplary vehicle 10 is shown. The vehicle 10 may be equipped with a navigation system 12. The navigation system 12 may be used to provide directional guidance from a present location of the vehicle 10 to a desired location. The navigation system 12 may be configured to allow a user to select and view a desired number of waypoints along a calculated route on a display unit of the navigation system 12. Waypoints may be generally defined as a set of coordinates that helps identify a point in space. For the navigation system 12, waypoints may be defined as points that help to define the calculated route. For example, the waypoints along the calculated route may be different points where the user may need to adjust a current path/direction such as where the user may need to make a turn, merge onto another road, and the like. The above listing is given as an example and should not be seen in a limiting manner.

Referring now to FIG. 2, in accordance with one embodiment, the navigation system 12 may have a processor 14, a location determining unit 16, a memory 18, a user interface 20, a display 22 and power source 24. Each of the above mentioned components of the navigation system 12 may be placed within a housing 26. The processor 14 may be coupled to the user interface 20, location determining unit 16, memory 18, and display 22, through wired or wireless connections to enable information to be exchanged between the various components. All or some of the components of the navigation system 12 may be powered via the power source 24.

The processor 14 may be used to control the various functions of the navigation system 12. The processor 14 may be implemented in hardware, software or a combination thereof. The processor 14 may store a computer program or other programming instructions associated with the memory 18 to control the operation of navigation system 12. The data structures and code within the software in which the present disclosure may be implemented, may typically be stored on a non-transitory computer-readable storage. The storage may be any device or medium that may store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed. The processor 14 may comprise various computing elements, such as integrated circuits, microcontrollers, microprocessors, programmable logic devices, etc, alone or in combination to perform the operations described herein.

When the navigation system 12 is active, the processor 14 may determine a current location of the vehicle 10 having the navigation system 12. In accordance with one embodiment, the processor 14 may receive location data from the location determining unit 16. The location determining unit 16 may be a Global Positioning Satellite (GPS) unit or the like. The above is given as an example and should not be seen in a limiting manner. The processor 14 may determine a current location of the vehicle 10 in other manners without departing from the spirit and scope.

The memory 18 may be coupled to the processor 14 as well as other components of the navigation system 12. The memory 18 may be used to store various data utilized by the processor 14 and or other components of the navigation system 12. The memory 18 may include removable and non-removable memory elements such as RAM, ROM, flash, magnetic, optical, and/or other conventional memory elements. The above listing is given as an example and should not be seen in a limiting manner.

The memory 18 may be used to store programming data for instructing the processor 14 or other components of the navigation system 12 to perform certain steps as will be described below. The memory 18 may also store various geographic map and navigation data, as well as data related to “points of interest” and the like. The above listing is given as an example and should not be seen in a limiting manner. The memory 18 may store other data without departing from the sprit and scope.

The user interface 20 may be coupled to the processor 14 as well as other components of the navigation system 12. The user interface 20 may be used to enter information into the navigation system 12. The user interface 20 may be buttons, switches, keyboard, trackball, scroll wheel or similar device used to enter data. In accordance with one embodiment, the display unit 22 may show an alphanumeric keyboard and the user interface 20 may be used to select and enter a desired letter and or number. Alternatively, the display unit 22 may be a touch screen display thereby functioning as a display unit 22 and the user interface 20.

The display 22 may be coupled to the processor 14 as well as other components of the navigation system 12. The display 22 may be used to show graphical representations of maps, routes, points of interest, and the like as will be detailed below. Further, as stated above, the display 22 may be used to show an alphanumeric keyboard to be used with or as the user interface 20. The display 22 may be a Cathode Ray Tube (CRT), Liquid Crystal Display (LCD) or the like. The above is given as an example and should not be seen in a limiting manner.

The power source 24 may be provided to supply power to the various components of the navigation system 12. Thus, the power source 24 may be used to directly or indirectly power the processor 14, the location determining unit 16, memory 18, user interface 20 and/or display 22. The power source 24 may be batteries, an adapter for running off of power supplied by the vehicle 10 or the like. The above is given as an example and should not be seen in a limiting manner.

Based on the current location identified, the processor 14 may display a graphical representation of a map showing the current location of the vehicle 10 on the display unit 22. The processor 14 may obtain map data from the memory 18. Alternatively, the processor 14 may download map data via the location determining unit 16 (i.e., the GPS unit). The above is given as an example and should not be seen in a limiting manner. The graphical representation of the map shown on the display 22 may be a two dimensional representation, a three dimensional representation, a satellite image representation, or the like. The above listing is given as an example and should not be seen in a limiting manner. Other graphical representations of the map may be used without departing from the spirit and scope. Further, the navigation system 12 may be configured such that the graphical representation of the map shown on the display 22 may change as different views of the map are shown on the display 22 as will be described below.

When the user wishes to search for and calculate a route from the current location of the vehicle 10 to a desired destination, the user may enter address data, name data or enter a type of point of interest such as (restaurants, gas stations, etc.) of the desired destination by using the user interface 20. Once the user has entered data related to the desired destination, a preferred route to the desired destination may be calculated. The processor 14 may calculate the preferred route using data obtained from the memory 18 and or the location determining unit 16.

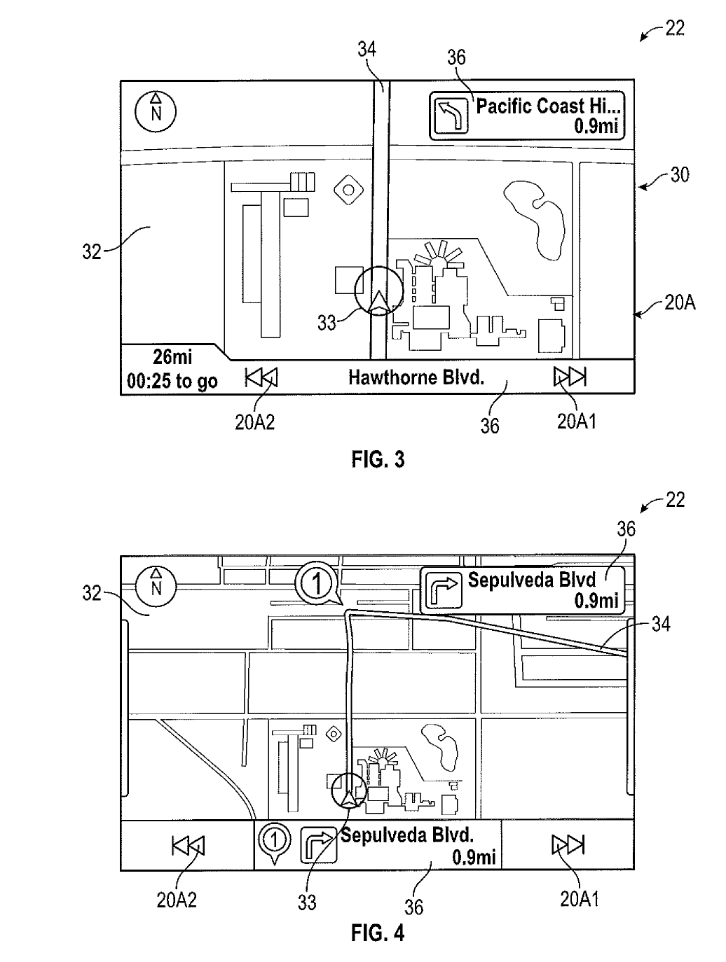

Referring now to FIGS. 1-6, operation of the navigation system 12 may be described. When the navigation system 12 is activated, the navigation system 12 may identify a current location of the vehicle 12. An initial screen view 30 may be generated as shown in FIG. 3. In general, the initial screen view 30 may show a graphical representation of a map 32. A graphical representation of the vehicle 34 may also be shown indicating a present location of the vehicle 12 on the map 32. If a route has been calculated, the preferred route 34 may be highlighted. The navigation system 12 may be dynamic such that as the vehicle 10 moves, the graphical representation of the map 32 and the position of the graphical representation of the vehicle 33 on the map 32 may be updated.

In general, in prior art navigation systems, the initial screen view 30 may only show the general area around where the vehicle 12 is presently located. Thus, prior art navigation systems have limited functionality as to allow the driver to zoom in or zoom out to see upcoming and or future waypoints on the preferred route 34.

The navigation system 12 may be configured to allow a user to zoom in and or zoom out to see a desired number of waypoints along the preferred route 34 that has been calculated. When a user enters destination data into the user interface 20, the navigation system 12 may calculate the preferred route 34 from the current location of the vehicle 10 to the desired destination.

Once the preferred route 34 has been calculated, the navigation system 12 may generate the initial screen view 30 as shown in FIG. 3. The navigation system 12 may have a waypoint user interface 20A. In the embodiment shown in FIG. 3, the waypoint user interface 20A may be a pair of arrow buttons 20A1 and 20A2. The arrow buttons 20A1 and 20A2 are shown as an example and should not be seen in a limiting manner. Other types of waypoint user interface 20A devices may be used without departing from the spirit and scope.

The waypoint user interface 20A may allow a user to select a desired number of waypoints ahead of a current position a user would like to view. Like the user interface 20, the waypoint user interface 20A may interface with the processor 14. Use of the waypoint user interface 20A may cause the processor 14 to execute a computer program to allow a user to zoom out or zoom in to see a desired number of waypoints along the preferred route 34 calculated ahead of a current position of the vehicle 10. By using the waypoint user interface 20A, the display unit 22 may show a graphical representation of a map showing the current location of the vehicle 10 as well as a desired number of waypoints ahead of the current position.

Since the initial screen view 30 may only show the general area around where the vehicle 10 is presently located, the user may wish to see one or more waypoints ahead of the present location. By using the waypoint user interface 20A, a user may select a desired number of waypoints ahead of the present location. For example, to see one waypoint ahead along with the current waypoint or waypoints, the user may press the arrow button 20A1 on the right side of the navigation system 12. Each additional push of the arrow button 20A1 on the right side of the navigation system 12 may increase by one, the number of additional waypoints to be seen. By pressing the arrow button 20A2 on the left side of the navigation system 12, the number of waypoints to be seen may decrease by one.

The navigation system 12 may be configured such that additional pressing of either arrow button 20A1 or arrow button 20A1 passed a maximum and or minimum number of viewable waypoints may have no effect on further adjusting the number of waypoints to be seen. For example, in the embodiment shown in FIG. 3, the preferred route 34 calculated may have five waypoints (1-5). The navigation system 12 may then generate the initial screen view 30 as shown in FIG. 3. If a user wishes to view the next waypoint ahead on the preferred route 34 calculated, the user may press the arrow button 20A1 one time. By pressing the arrow button 20A1 one time, the processor 14 may execute a computer program to allow a user to zoom out to view the next waypoint ahead of the current position on the preferred route 34 as may be seen in FIG. 4.

The navigation system 10 may further generate one or more text boxes 36. Each text box 36 may be used to convey additional information to the user. For example, one text box 36 may display information related to a current position of the vehicle 12. For example, the text box 36 may display the name of the street where the vehicle 12 is currently driving. As seen in FIG. 3, the text box 36 shown on the bottom of the display 22 may show that the vehicle 12 is currently on Hawthorne Blvd. Another text box 36 may be used to show additional information related to a waypoint to which the user zoomed out to view. For example, in FIG. 4, the text box 36 may show that at waypoint 1, the user may need to make a turn at a certain street location. In the embodiment shown in FIG. 4, the text box 36 provides visual written directions that the user needs to make a right hand turn at Sepulveda Blvd and that turn is approaching in 0.9 miles. The above is given as an example and should not be seen in a limiting manner. Other information may be displayed in the text box 36 without departing from the spirit and scope.

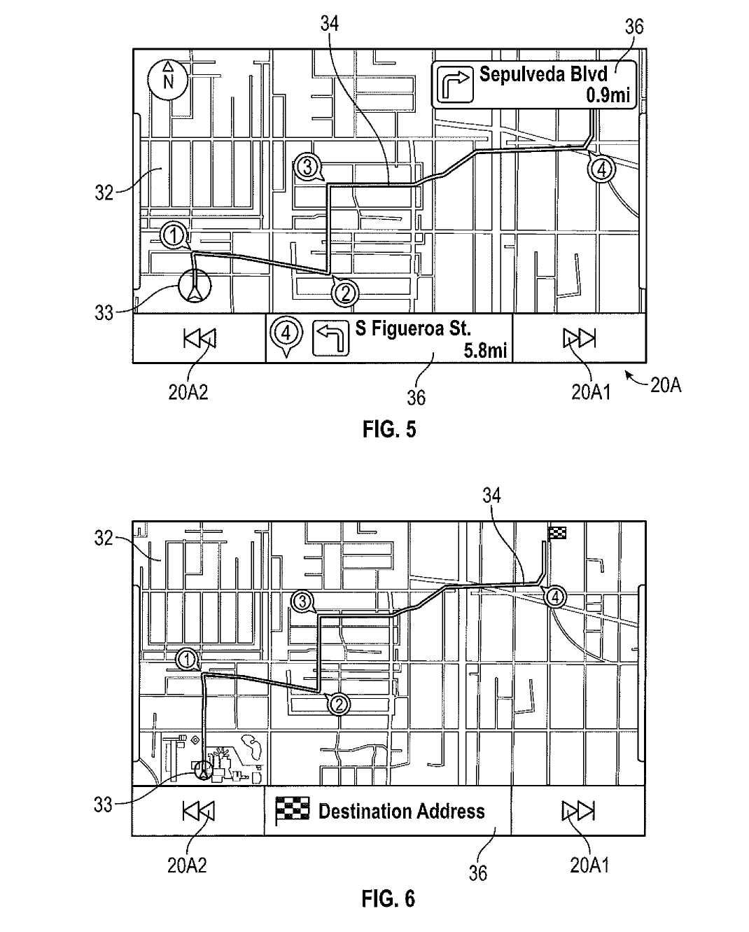

If the user wishes to view four (4) waypoints ahead, from the present screen shown in FIG. 4, the user may press the arrow button 20A1 three additional times for a total of four presses (i.e., the initial press to zoom out to see the waypoint 1 plus three additional presses). The navigation system 12 may then generate the screen view 40 as shown in FIG. 5 showing four (4) waypoints (1-4) ahead of the current position along the preferred route 34. From the screen view shown in FIG. 5, if the user were to press the arrow button 20A1 two additional times, the navigation system 12 may only zoom out one additional time to show the fifth and final waypoint 5 (i.e. the destination) as may be seen in FIG. 6. An additional pressing of the arrow button 20A1 may not change the view shown in FIG. 6 on the display 22 as all waypoints along the preferred route 34 are shown.

Similarly, by pressing the arrow button 20A2, the user may zoom-in and lessen an amount of waypoints that may be seen. For example, from the screen shown in FIG. 6, if the user presses the arrow button 20A2 one time, the navigation system 12 may then generate the screen as shown in FIG. 5 showing four (4) waypoints 1-4 ahead of the current position along the preferred route 34. If the user presses the arrow button 20A2 three additional times, the navigation system 12 may then generate the screen view as shown in FIG. 4 showing one (1) waypoint 1 ahead of the current position along the preferred route 34. If the user presses the arrow button 20A2 one more time, the navigation system 12 may then generate the screen view as shown in FIG. 3. A further pressing of arrow button 20A2, the navigation system 12 may further show the screen view as shown in FIG. 3.

In accordance with one embodiment, further pressing of the arrow button 20A1 past the maximum number of waypoints or further pressing of the arrow button 20A2 past the minimum number of waypoints may perform other functions. For example, once the display 22 shows all future waypoints ahead of the current position, further pressing of the arrow button 20A1 may perform functions such as adjusting the settings of the display 22 (i.e., brightness level, contrast level, etc.), volume level of the navigation system 12, and the like. The above is given as examples and should not be seen in a limiting manner. Similarly, once the display 22 shows the current position, further pressing of the arrow button 20A2 may perform similar functions as disclosed above.

The navigation system 12 may be a dynamic system. Thus, as the vehicle 10 moves, the graphical representation of the map 32 and the position of the graphical representation of the vehicle 33 on the map 32 may be updated. Once the vehicle 10 moves past waypoint 1, the user may be allowed to zoom out and see at most 4 additional waypoints (i.e., waypoints 2-5). In operation, when the vehicle 10 moves past waypoint 1, pressing the arrow button 20A1 one time may cause the navigation system 12 to zoom out and show waypoint 2. Thus, once the vehicle 10 moves past waypoint 1, the user may zoom out to see the remaining 4 waypoints 2-5. Similarly, the user may zoom back in to see waypoints 2-4 as well as the current location which is past waypoint 1.

In accordance with one embodiment, the navigation system 12 may be configured such that the initial screen view 30 showing the general area around where the vehicle 10 may be displayed in a first graphical setting, for example as a three dimensional representation or satellite representation. As the user zooms out to see one or more waypoints ahead of the present location, the graphical representation of the map 32 may change from the first graphical setting to a second graphical setting. As the user continues to zoom out to see even more waypoints along the preferred route 34, the graphical representation of the map 32 may further change to a third graphical setting. For example, the initial screen view 30 showing the general area around where the vehicle 10 may be displayed as a satellite representation. If the user zooms out to see the next waypoint ahead of the current position, the graphical representation of the map 32 may change to a three dimensional representation. If the user zooms out to see two or more waypoint ahead of the current position, the graphical representation of the map 32 may change to a two dimensional representation. The above is given as an example and should not be seen in a limiting manner.

While embodiments of the disclosure have been described in terms of various specific embodiments, those skilled in the art will recognize that the embodiments of the disclosure may be practiced with modifications within the spirit and scope of the claims.

What is claimed is:

1. A navigation system comprising:
a display;
a processor coupled to the display; and
a memory coupled to the processor, the memory storing program instructions that when executed by the processor, causes the processor to:
calculating a route from a present location to a desired destination; and
displaying on the display a graphical representation of a map showing the present location and a desired number of waypoints along the route, wherein the desired number of waypoints is entered by a user through a user interface of the navigation system.

2. The navigation system, in accordance with claim 1, wherein the user interface is configured to increase and decrease the desired number of waypoints along the route to be viewed on the graphical representation of the map.

3. The navigation system of claim 2, wherein entering a number using the user interface greater than or equal to a maximum number of waypoints along the route calculated causes the processor to display on the display the graphical representation of the map showing the maximum number of waypoints along the route calculated.

4. The navigation system of claim 2, wherein entering a number using the user interface less than a minimum number of waypoints along the route calculated causes the processor to display on the display the graphical representation of the map showing the present location and proximate area around the vehicle having the navigation system.

5. The navigation system of claim 1, wherein the program instructions causes the processor to generate at least one text box on the display.

6. The navigation system of claim 5, wherein the text box showing information related to a next waypoint from the current position when the graphical representation of the map shows the desired number of waypoints along the route entered by the user,

7. The navigation system of claim 1, wherein the navigation system is dynamic, wherein the user interface is configured to one of increase or decrease the desired number of waypoints to be viewed causes the processor to display on the display the graphical representation of the map showing the desired number of waypoints along the route calculated in front of the current position.

8. The navigation system of claim 1, wherein the graphical representation of a map showing the present location is displayed in a first graphical setting and the graphical representation of the map showing a desired number of waypoints along the route is shown in a second graphical setting.

9. A navigation system comprising:
a processor;
a location determining unit coupled to the processor;
a display coupled to the processor;
a user interface coupled to the processor for entering data into the navigation system, wherein the user interface is configured to enter a desired number of waypoints to be viewed; and
a memory coupled to the processor, the memory storing program instructions that when executed by the processor, causes the processor to:
determine a present location of the navigation system by receiving data from the location determining unit;
calculating a route from the present location to a desired destination; and
displaying on the display a graphical representation of a map showing the present location and the desired number of waypoints along the route calculated.

10. The navigation system, in accordance with claim 9, wherein the user interface is configured to increase and decrease the desired number of waypoints along the route to be viewed on the graphical representation of the map.

11. The navigation system of claim 10, wherein entering a number using the user interface greater than or equal to a maximum number of waypoints along the route calculated causes the processor to display on the display the graphical representation of the map showing the maximum number of waypoints along the route calculated.

12. The navigation system of claim 10, wherein entering a number using the user interface less than a minimum number of waypoints along the route calculated causes the processor to display on the display the graphical representation of the map showing the present location and proximate area around the vehicle having the navigation system.

13. The navigation system of claim 9, wherein the program instructions cause the processor to generate at least one text box on the display when the graphical representation of the map shows the desired number of waypoints along the route entered by the user, the text box showing information related to a next waypoint from the current position.

14. The navigation system of claim 9, wherein the navigation system is dynamic, wherein the user interface is configured to one of increase or decrease the desired number of waypoints to be viewed causes the processor to display on the display the graphical representation of the map showing the desired number of waypoints along the route calculated in front of the current position.

15. The navigation system of claim 9, wherein the graphical representation of a map showing the present location is displayed in a first graphical setting and the graphical representation of the map showing a desired number of waypoints along the route is shown in a second graphical setting.

16. A method of displaying a map on a display of a navigation system comprising:
determining a current location of the navigation system;
calculating a route from the current location to a desired destination;
displaying a map showing the present location;
entering a desired number of waypoints ahead of the current location to be viewed; and
displaying on the display the map showing the desired number of waypoints along the route calculated.

17. The method of claim 16, further comprising generating at least one text box on the display, the at least one text box showing information related to a next waypoint from the current position.

18. The method of claim 16, wherein the map showing the present location is displayed in a first graphical setting and the map showing a desired number of waypoints along the route is shown in a second graphical setting.

19. The method of claim 16, wherein entering a desired number of waypoints ahead of the current location to be viewed comprises one of increasing or decreasing the desired number of waypoints to be viewed along the route by updating the desired number using a user interface of the navigation system.

20. The method of claim 16, wherein the navigation system is dynamic, wherein using a user interface to one of increase or decrease the desired number of waypoints to be viewed generates the map showing the desired number of waypoints along the route calculated in front of the current position.
